(19) United States
(12) Patent Application Publication
(10) Pub. No.: US 2018/0071555 A1
(43) Pub. Date: Mar. 15, 2018

(54) RESCUE TOOL

(71) Applicant: N. V. Holmatro, Raamsdonksveer (NL)

(72) Inventor: Antonius Johannes Henricus Bruurs, Tilburg (NL)

(73) Assignee: N. V. Holmatro, Raamsdonksveer (NL)

(21) Appl. No.: 15/541,125

(22) PCT Filed: Jan. 4, 2016
(86) PCT No.: PCT/NL2016/050001

§ 371 Date: Jun. 30, 2017

(30) Foreign Application Priority Data
Jan. 8, 2015 (NL) 2014095

(51) Int. Cl. A62B 3/00

(52) U.S. Cl. CPC A62B 3/005

(57) ABSTRACT

The invention relates to a rescue tool, comprising a power cylinder having a cylinder housing and a piston with a piston rod extending out of the housing, a transmission connected to the piston, at least one rotatably drivable arm, a structure accommodating at least the cylinder housing; and a yoke, which defines a passage for any one or more than one of the cylinder housing, the piston and the transmission and which is connected to the structure to define a rotation point for the at least one rotatably driveable arm. The rescue tool further comprises an end-cap, which is arranged on the cylinder housing to close an internal pressure chamber of the cylinder, wherein the yoke and the end-cap form an integral component.

The present disclosure relates to rescue tool, such as a spreader or a cutter.

The inventors of the present disclosure are exclusively aware of such tools, comprising a power cylinder, a transmission and at least one rotatably drivable arm, such as a pusher or a cutter blade. Such arms of prior art configurations require provision of at least one rotation point or axis, to be able to drive these arms in a rotational movement. To this end, in the prior art, at least one yoke is clamped onto a structure accommodating the power cylinder.

Exemplary prior art disclosures, that are acknowledged here, are CN-102462901, U.S. Pat. No. 2,643,562, DE-29507457 and U.S. Pat. No. 3,819,153, relative which at least the features defined in the characterising portion of the single appended independent claim are novel and inventive.

These prior art configurations exhibit disadvantages and drawbacks. For example, because the yoke is clamped onto the structure in the prior art, there's a considerable distance between a movement direction of a piston rod of the cylinder and clamping point(s) of the yoke. As a consequence, when the cylinder is operated, for instance by supply of hydraulic fluid thereto, considerable forces in directions perpendicular to the line or direction of movement of the piston rod are generated. To withstand such perpendicular forces, the structure, the transmission and the yoke, as well as an attachment of the yoke to the structure, all need to be very strong and robust, which often translates into bigger dimensions, thereby inherently aggravating the problem, since bigger dimensions cause an even larger distance between the direction of movement of the piston rod and the clamping point(s) of the yoke. Naturally, a balance can be determined to take both robustness and compactness into account, but generally there's a need for more compact rescue tools, to enable rescue workers to reach more difficult areas, for example at a crash site, and enable more effective rescue of for example crash victims.

To this end, the present disclosure is intended to reduce or even resolve any one or more than one of the identified or other problems of the prior art constructions. To this end, a rescue tool is disclosed herein, comprising: a power cylinder having a cylinder housing and a piston with a piston rod extending out of the housing; a transmission connected to the piston; at least one rotatably drivable arm; a structure accommodating at least the cylinder housing; and a yoke, which defines a passage for any one or more than one of the cylinder housing, the piston and the transmission and which is connected to the structure to define a rotation point for the at least one rotatably driveable arm.

With a rescue tool according to the present disclosure, a more compact configuration can be designed and achieved, which may be embodied in a lest robust and big manner, to allow an elegant and simpler configuration and enable rescue worker to reach more difficult places. Further, the rescue tool according to the present disclosure exhibits the feature that the yoke has a bus shaped connector for connection to the cylinder. Thereby a sturdy support onto the structure of the rescue tool may be provided.

The rescue tool may have the additional feature, that an end-cap is releasably arranged on the cylinder housing to close an internal pressure chamber of the cylinder. This allows for a simple cylinder design, which can easily be disassembled and maintained, for example if the end-cap is screwed onto the cylinder housing. Yet further, the rescue tool exhibits the additional feature, that the yoke and the end-cap form an integral component. This allows for an ultimate saving of space and an optimal down scaling of the design, to result in a very compact configuration that enables deployment of the rescue tool in very tight spaces. Moreover, when disassembly and maintenance of the cylinder interior is desired, the yoke and end-cap can be removed together in a single operation, and can also be arranged back on the cylinder very simply in a single operation.

The basic idea of the present disclosure can have many appearances and embodiments, which will be described below under reference to the appended drawing and/or which are defined in appended dependent claims. Some aspects of embodiments of rescue tools according to the present disclosure are referred to below, where it should be noted that neither the appended claims, nor the below embodiment description can result in any limitation in scope of protection thereto, in lieu of the more generic definition of all embodiments according to the present disclosure according to the appended independent claim. Even the independent claim may contain a definition of a feature, for which in the future an as yet unforeseeable alternative may be implemented, and embodiments having such future alternative features are also to be interpreted as comprised within the scope of protection for all embodiments according to the present disclosure.

Additionally, the rescue tool may exhibit the feature that the end-cap of the cylinder comprises a sealed passage for the piston rod. In particular for embodiments with integrated end-cap and yoke combinations, this feature emphasizes how the end-cap carries the yoke to make the total resulting configuration more compact, and also keep distances relevant for force control to a minimum.

According to the present disclosure having the bus shaped connector, the rescue tool may further exhibit the feature that the bus shaped connector has an internal or external screw thread and the either one of the cylinder and the structure has an opposite screw thread. Thereby the connector can conveniently be assembled onto the structure or onto the cylinder, and also disassembled for maintenance or repair, whereas prior art rescue tools of this type usually require welding together of components to achieve a sufficiently robust configuration, but which hampered maintenance or repair, or which manner of assembly required provision of separate measures or means to allow for maintenance or repair.

Following the above discussion of embodiments of rescue tools according to the present disclosure in more generic terms, corresponding with the features defined in the appended claims, herein below a more detailed description is provided, referring to the appended drawing. As indicated above, in particular features of specific embodiments will be disclosed in order to comply with the requirement of sufficient disclosure, but none of the specifically revealed features of particular embodiments should be interpreted as imposing any limitation whatsoever on the scope of protection for the assembly of embodiments according to the present disclosure, in as far as covered by in particular the independent claim of the set of appended claims. Moreover, in separate figures of the appended drawing, the same or similar aspects, elements and components can be indicated using the same reference numbers. In the appended drawing:

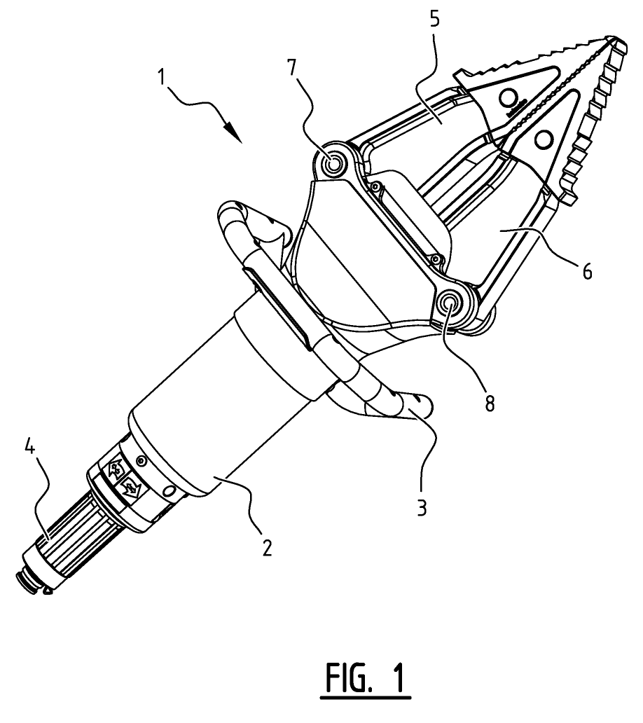

FIG. 1 shows a perspective view of a spreader as a potential embodiment of a rescue tool according to the present disclosure;

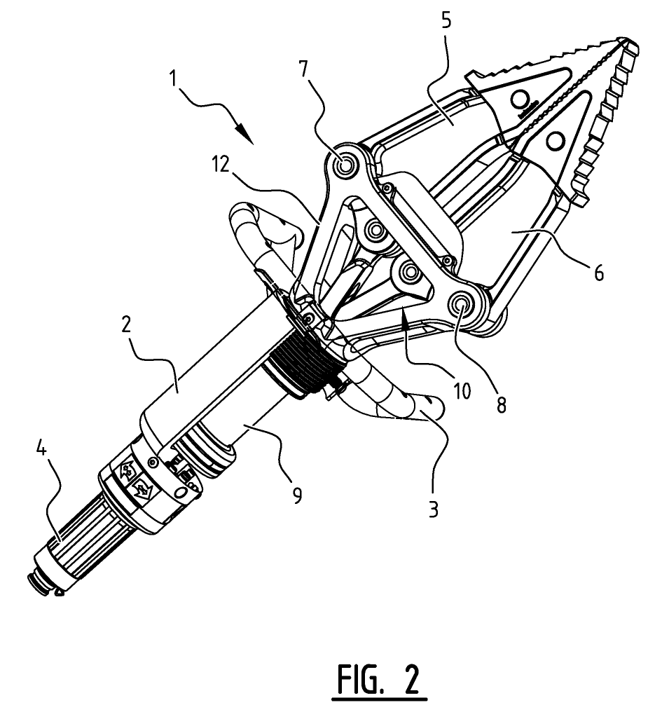

FIG. 2 shows a perspective view of the same spreader as in FIG. 1, but in a partially broken open representation;

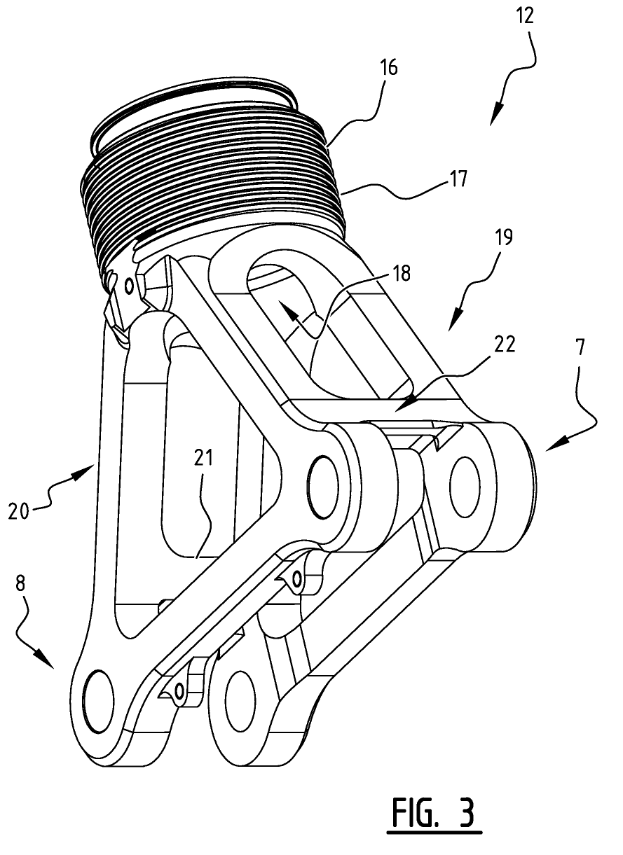

FIG. 3 shows a perspective view of a detail of an integrated cylinder end-cap with yoke; and

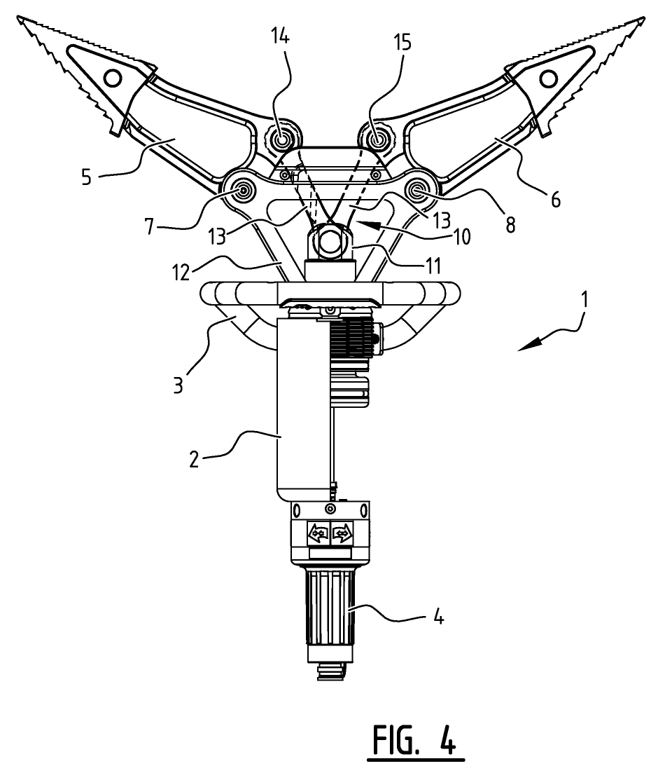

FIG. 4 shows a frontal view of the spreader according to FIGS. 1 and 2 in a spread open state.

In FIGS. 1 and 2, a spreader 1 is shown. Spreader 1 is an exemplary embodiment of a rescue tool according to the present disclosure, and alternatively the present disclosure could also relate to a cutter, or the like.

Spreader 1 comprises a spreader housing 2, forming a structure of the spreader. The housing is referred to as forming a structure in that thereby separate components may be connected, such as handlebar 3 and a connector 4 to connect a hydraulic hose (not shown in) to the spreader 1. Spreader housing 2 accommodates a cylinder 9, which may be hydraulic, and connection to a hydraulic power source via connector 4 may then serve to drive cylinder 9.

Extending out of cylinder 9 is a piston rod 11, as shown in FIG. 4. Piston rod 11 is connected via a transmission 10 to two rotatably driveable arms 5, 6, which are rotatably connected to a yoke 12 in rotation points 7, 8.

Transmission 10 essentially comprises two push bars 13, which are rotatably connected to piston rod 11 and two rotatable connection points 14, 15 of respectively arms 5, 6.

When cylinder 9 is driven to extend piston rod 11, push bars 13 transmit extension movement of piston rod 11 to arms 5, 6, which are in the exhibited configuration then driven to swivel outward relative to rotation points 7, 8 on yoke 12.

As indicated above, the present disclosure could just as easily relate to a cutter instead of a spreader 1, which would merely require an alteration in transmission 10 or in a connection of arms 5, 6 to yoke 12 and require reversal of the powered motion to forcibly close arms 5, 6 together. Preferably, in an embodiment of the cutter, arms 5, 6 would require having sharp inward oriented

FIG. 3 shows a perspective view in more detail of yoke 12, which is in fact an integrated embodiment of both yoke 12 and an end-cap 16 for cylinder 9. End-cap 16 is provided with external screw thread 17, and a cylinder housing of cylinder 9 would have a counter screw thread in the interior of a tubular cylinder housing. Consequently, end-cap 16 of integrated yoke 12 can be screwed onto the end of such a cylinder housing of cylinder 9.

End-cap 16 is bus shaped to have an internal passage 18 to allow piston rod 11 to extend their through. In FIG. 3, transmission 10 with push bars 13 and arms 5, 6 are omitted for the sake of clarity, but by indicating rotation points 7, 8 it will be clear to the skilled person how and where arms 5, 6 are to be connected to yoke 12 in or at the rotation points 7, 8.

End-cap portion 16 of integrated yoke 12 can have internal screw thread, instead of the shown external screw thread 17 of the embodiment in FIG. 3.

Integrated yoke 12 further comprises two triangular structures 19, 20, each connecting end-cap 16 with a pair of through holes, defining rotation points 7, 8. For robustness of the resulting configuration, triangular structures 19, 20 are interconnected by transverse beams 21, 22, which connect the triangular structures 19, 20 in the vicinity of the rotation points 7, 8.

Although details of the present disclosure relate to specific features of the embodiments shown in the appended drawings, the skilled person will immediately, after having been confronted with the technical details and the more generic underlying considerations, be able to reproduce a rescue tool according to the present disclosure, even though that would fall within the scope of protection according to the present disclosure, and also be able to configure at least one alternative for any specific embodiment, aspect, element or feature, as shown in the appended drawing and described herein above. Consequently, all such additional and/or alternative embodiments are to be interpreted as lying within the scope of protection for the present disclosure in accordance with the appended claims.

1. A rescue tool, comprising:
a power cylinder having a cylindrical cylinder housing and a piston with a piston rod extending out of the housing;
a transmission connected to the piston;
at least one rotatably drivable arm;
a structure accommodating at least the cylinder housing; and
a yoke defining a passage for any one or more than one of the cylinder housing, the piston and the transmission, and which is connected to the structure to define a rotation point for the at least one rotatably driveable arm, and
an end-cap arranged on the cylinder housing to close an internal pressure chamber of the cylinder,
wherein the yoke and the end-cap form an integral component, and
wherein the yoke has a bus shaped connector for connection to the cylinder.

2. The rescue tool according to claim 1, wherein the end-cap of the cylinder comprises a sealed passage for the piston rod.

3. The rescue tool according to claim 2, wherein the bus shaped connector has an internal or external screw thread and the cylinder has an opposite screw thread.

4. The rescue tool according to claim 1, wherein the bus shaped connector has an internal or external screw thread and the cylinder has an opposite screw thread.
